(19) United States
(12) Patent Application Publication
(10) Pub. No.: US 2005/0264216 A1
(43) Pub. Date: Dec. 1, 2005

(54) Energy-saving Modular Compact Fluorescent Lamp With A Detachable Glass Bulb Unit

(76) Inventors: Sean Siehoon Lee, Irvine, CA (US); Iksoo Park, Irvine, CA (US)

Correspondence Address: Sean S. Lee, 1 Driftwood, Irvine, CA, 92604, US

(21) Appl. No.: 10/908,660

(22) Filed: May 21, 2005

Related U.S. Application Data
(60) Provisional application No. 60/576,038, filed on Jun. 1, 2004.

(51) Int. Cl. H01K 1/62

(52) U.S. Cl. 315/58

(57) ABSTRACT

A modular compact fluorescent lamp integrated with automated on/off control that is comprised of two modules. The glass bulb unit (daughter unit) is separated from the main body and can be exchanged and refilled at a lower cost. The main body unit (mother unit) contains the most electrical circuitry control, extends the reliability of the product by reducing heat-generating components, and is designed to accommodate various colors and applications of the daughter unit without increasing the size of the compact fluorescent lamp.

### BACKGROUND OF THE INVENTION

Fluorescent lighting technology has been available for over 50 years and has been gradually supplanting a “normal light bulb”, also known as an incandescent bulb, owing to their huge energy saving and four to six times higher efficiency to produce the same lumens per watt than the incandescent lamp. Compact fluorescent lamps that come with integrated ballast make it more popular as an energy-saving alternative to incandescent lamps in the commercial indoor and residential lighting. They typically have a standard screw base that can be installed into any table lamp or lighting fixture that accepts an incandescent bulb.

The downside is that they can still cost 6˜10 times more than the incandescent bulb and pose inherent design limitation in size to have additional features to meet various application needs; its physical dimension tends to be larger than the incandescent bulb they replace and may not fit the fixture. Another shortcoming is that the color is generally cooler or remits too much yellow and green spectrum output than incandescent bulbs and natural sunlight, so it may not provide desirable color rendering capability for certain working environment. Latest development of full spectrum lighting technology presents some improvements that utilize special phosphors or filtering device to produce more balanced out, but the product is still prohibitively expensive.

The task of this invention is to close these gaps, by introducing a modular concept of compact fluorescent lamp, and hence makes the product economically more viable to manufacture and market at a lower price point. At the same time this approach presents new possibilities to enable various applications thorough the main control unit without increasing the size of the compact fluorescent lamp.

### SUMMARY OF THE INVENTION

The invention presents a modular compact fluorescent lamp (CFL) that can separate the glass bulb unit (daughter unit) from the main control body (mother unit). The daughter unit contains disposable components and can be designed for various applications, such as full spectrum light bulb unit, and for various colors, and can be conveniently exchanged and refilled into the mother unit at a lower cost.

The mother unit contains main electronic circuitry and socket base that is compatible with incandescent bulb and connectors for the daughter unit, removes filament-heating components, such as thermistor and condensers, through the use of glow starter in the daughter unit. The extra space required in the CFL circuitry is no more necessary by removing those filament-heating components, and hence improves the design flexibility and reliability of the product. Automated on/off control is incorporated using cds light sensor to more effectively reflect various lighting conditions in indoors other than natural sunlight.

### DETAILED DESCRIPTIN OF THIS INVENTION

This invention presents a modular design of compact fluorescent lamp integrated with automated on/off control. The approach consists of two units: a mother unit and a daughter unit. The mother unit contains a main electronic circuitry that incorporates a variety of control functions for the daughter unit; and the daughter unit features a removable, fluorescent glass tube unit that can be easily attached to the mother unit through a locking socket mechanism and plug pin connectors.

The benefit of this invention is: (1) To lower the overall cost of the compact fluorescent lamp with the use of disposable daughter unit that can be exchanged and refilled at a lower cost; (2) To improve the cost, size, and reliability in CFL design by reducing heat-generating components; (3) To enable design flexibility in the mother unit by utilizing extra space once reserved for those heat-generating components and that enables various applications in the mother unit without increasing the size of the product; (4) To integrate automated on/off control using cds light sensor to more effectively reflect various lighting conditions in indoors other than sunlight.

FIG. 1 shows an example of a conventional circuit design of compact fluorescent lamps. Alternating current is converted into direct current that enables alternate high-speed switching between transistors (1a and 1b) in the inverter. The inverter generates high frequency electronic waves and heats up the filament through condensers (5a and 5b) and thermistor (6) to prepare for the ignition. While the thermistor contributes for the ignition at the initial stage by heating up the filament with high current, the high degree of heat and high current preserved in the circuitry tends to negatively affect the circuitry and the life of the fluorescent lamp after the ignition process. In addition, the extra space reserved around the thermistor due to the heat generating nature of this temperature dependent semiconductor poses a size limitation in compact fluorescent lamp, thus making it difficult to maintain the “compact” form factor if you want to incorporate extra features, such as energy-saving circuitry or detachable daughter unit without adjusting the overall size of the product.

This invention presents a solution for this issue with the use of detachable design of the daughter unit and the application of the glowstarter to the daughter unit. FIGS. 4 & 5 show the mother unit that is designed to accommodate the daughter unit and FIG. 6 shows socket and connectors of the mother unit and the daughter unit that includes glass tube and a locking mechanism with plug-type connectors. The use of glowstarter to the compact fluorescent lamp design poses some distinctive advantages. First, cost and extra space saving can be achieved by eliminating filament-heating condensers (5a and 5b) and thermistor (6). It also extends the reliability of the main circuitry and the life of compact fluorescent lamp by reducing high temperature and current after the ignition process. It is known that about 20% of the early breakdown of CFL is associated with those temperature dependent semiconductors. In addition, this approach helps to develop the modularity of CFL by separating the daughter unit, which contains disposable parts, such as glass tube, and that can be easily exchanged and refilled at a lower cost while keeping the mother unit. In this approach, the full spectrum light is also available at a lower price by utilizing special phosphors to balance the spectrum output or applying pigmented filter in the fluorescent tube of the daughter unit. FIG. 5 shows the choke coil (4) of the mother unit to control and discharge the current. The choke coil is positioned between socket (10) and connecting base (11).

As described earlier, the modular design used in this invention allows us to add extra features in the main circuitry without increasing the size. FIG. 2 shows additional energy saving feature that is incorporated into the main circuitry. Most automated on/off control is primarily designed for incandescent lamps and outdoors and is based on the sensing mechanism that reflects the spectrum output of the sunlight. The drawback is that when we are under various artificial lighting sources other than the natural sunlight, the sensing mechanism may not accurately reflect the surrounding lighting condition.

FIG. 2 shows alternative approach taken in this invention to improve this situation. The upper portion shows electronic high frequency ballast that controls the ignition and that is centered on the switching transistors (1a and 1b). The lower portion shows timer (50) and cds sensor (51) that generate signals for automated on/off control and the upper portion of the circuit is controlled through transistor (1c). The electronic high frequency ballast replaces those filament-heating components (5a, 5b, 6) shown in FIG. 1 with glowstarter (23). Current is converted through rectifying diode (D1-4) and filter capacitor (C1). And transistor (1a) is turned on through resistor (R3), condenser (C2) and DIAC (D6). Once the transistor (1a) is on, the current increases electric charge through condenser (C4), pulse trans coil (3a), choke coil (4) and generates forward EMF in the pulse trans coil (3a), which makes transistor (1a) maintain the status.

As electric voltage in the condenser (C4) increases, the charging current decreases and the pulse coil (3c) generates backward EMF, which makes transistor (1a) turned off. Transistor (1b) is turned on by the forward EMF generated by the pulse coil (3b) and discharging current flows through condenser (C4). The lamp is then turned on by the inductance of the choke coil (4) and the counter electromotive force flows through the diode (D8). The discharging current decreases by transistor (1b) and condenser (C4) and the forward EMF generated by pulse coil (3c) makes transistor (1a) on and transistor (1b) is turned off. This process is repeated, which makes 35 KHz-switching.

The lower diagram in FIG. 2 regards the automated on/off control signals. The electric current is supplied through resistor (R9), filter capacitor (C5) and Zener Diode (ZD) and FIG. 9 describes the change of the signal. The circuit around the timer (50) shows typical pulse generating process. In every 10 minutes about 200 ms pulse signals (High: 6.5v, Low: 0v) are generated by terminal (3). These pulse signals are changed the voltage (High: 5.4v, Low_{—}2.2v) through OP AMP inverting terminal (53) and resistors (R12, R13, R14) and are entered to Schmitt Trigger (52).

The right hand side of FIG. 3 shows the electronic circuit that is triggered by Schmitt Trigger (52) when the input exceeds a predetermined threshold level. The output voltage is maintained until the input falls below the threshold level. For example, when surrounding lighting condition is getting dark, it changes the illumination intensity and hence increases the cds value. When the output of Schmitt Trigger (52) increases beyond the predetermined threshold level (Low: 2.2v), the output voltage increases via resistor (R16) and turns on the transistor (TR1). The signal is feedback through resistor (R19), maintains the voltage level, and keeps the lamp turned on. The Schmitt Trigger (52) checks the voltage every 10 minutes. When it senses High threshold level (5.4v), it makes the output voltage Low (0v). Then the lamp is turned off.

The Schmitt Trigger interfaces with electronic high frequency ballast that controls the on/off switch when the output signal hits High/Low respectively. Transistor TR1 is turned off when the output signal of Schmitt Trigger (52) hits Low (0v) and is turned on again when the voltage changes through resistor (R1) and transistor (1c). Then the base voltage is bypassed to the collector-emitter of transistor (1c) and makes transistor (1a) stop working, which prevents the lamp from turning on. When the output signal from Schmitt Trigger (52) hits High (5.2v), transistor (TR1) is turned on. Then the base voltage becomes zero and transistor (1c) is turned off. The switching transistor (1a) is then triggered by DIAC (D6) and the lamp is turned on by the switching process.

### BRIEF DESCRIPTION OF THE DRAWINGS

FIG. 1 shows electrical circuitry of conventional compact fluorescent bulb

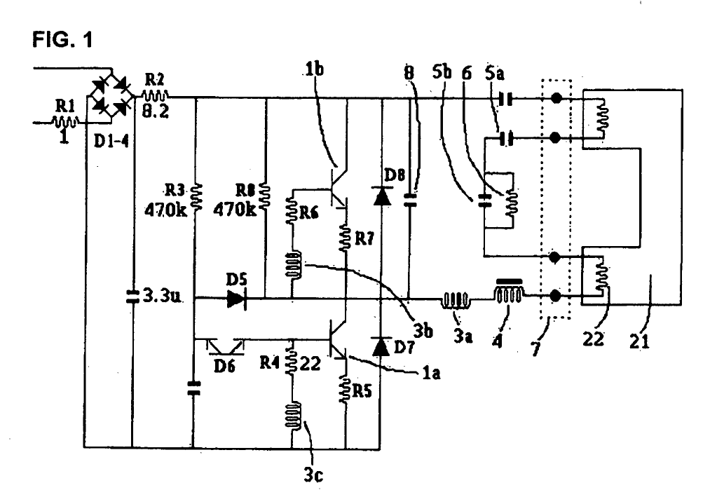

FIG. 2 shows electrical circuit employed in this application that incorporates the detachable bulb unit

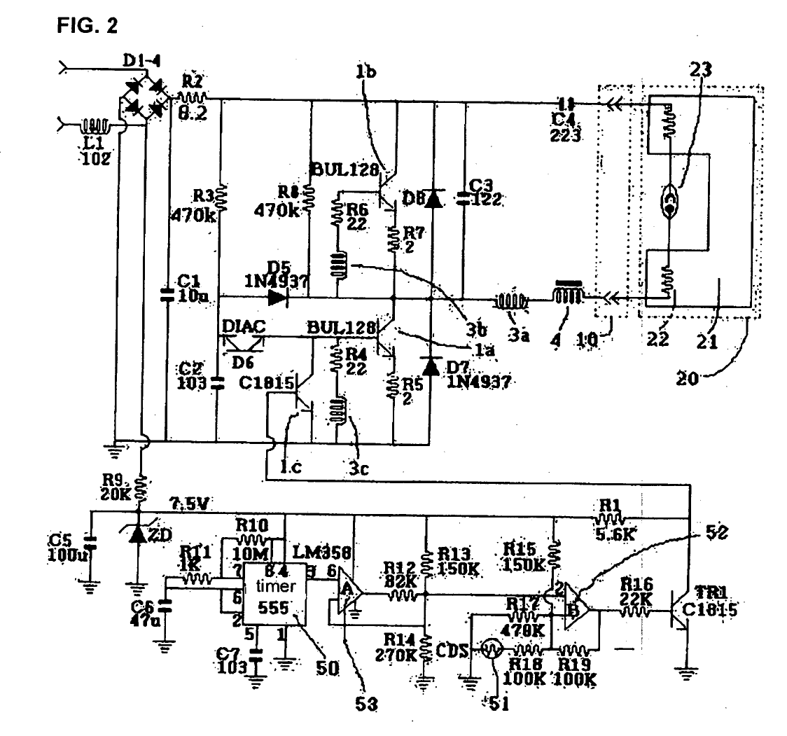

FIG. 3 shows conventional compact fluorescent bulb

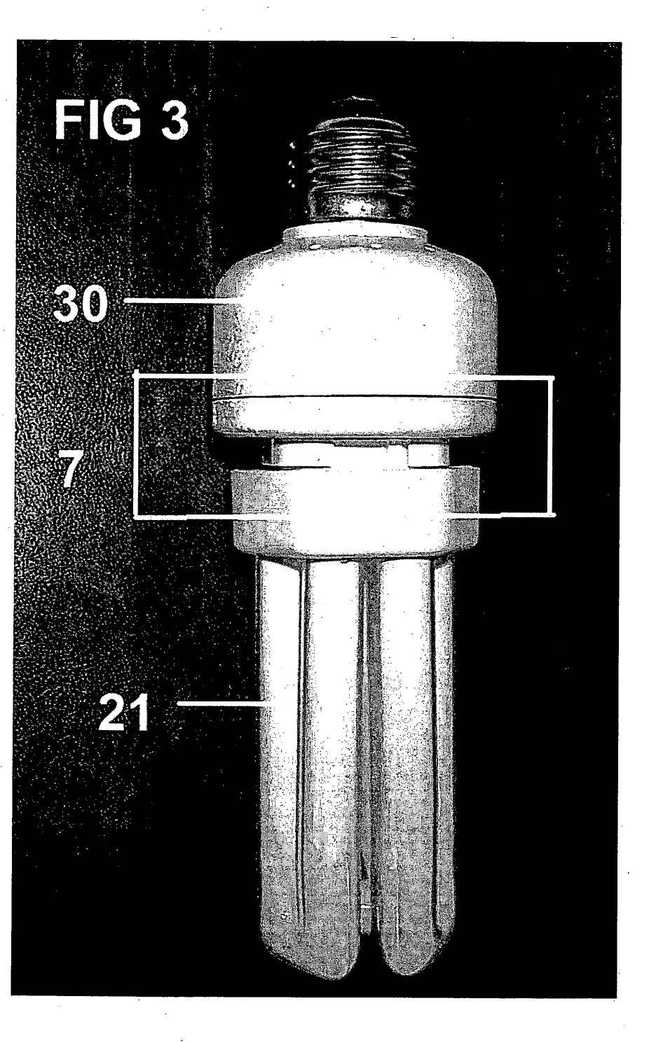

FIG. 4 shows the mother unit of this invention that is designed to separate the daughter unit

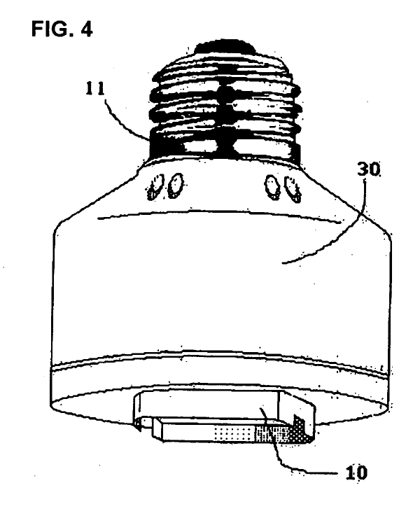

FIG. 5 shows perspective drawing of the mother unit

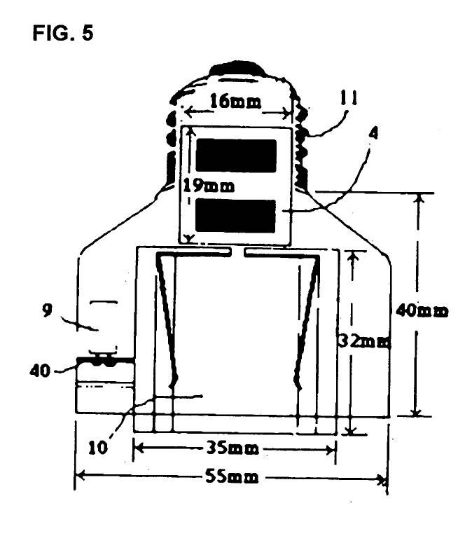

FIG. 6 shows the connectors between mother unit and daughter unit

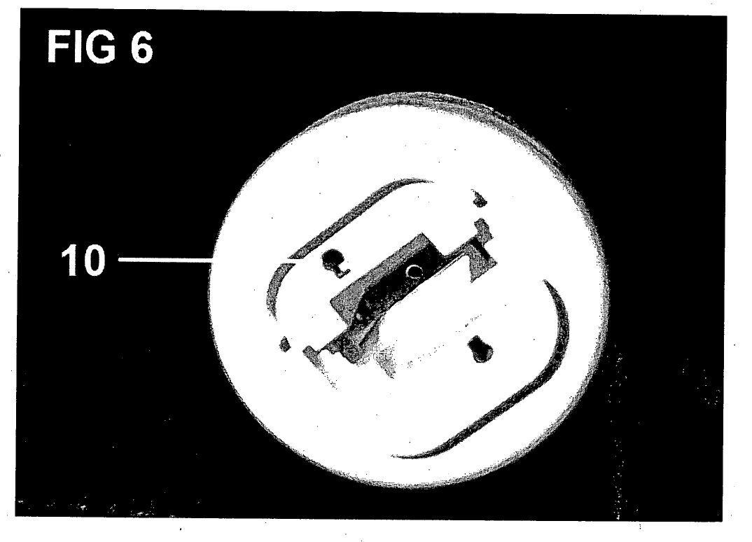

FIG. 7 shows the daughter unit

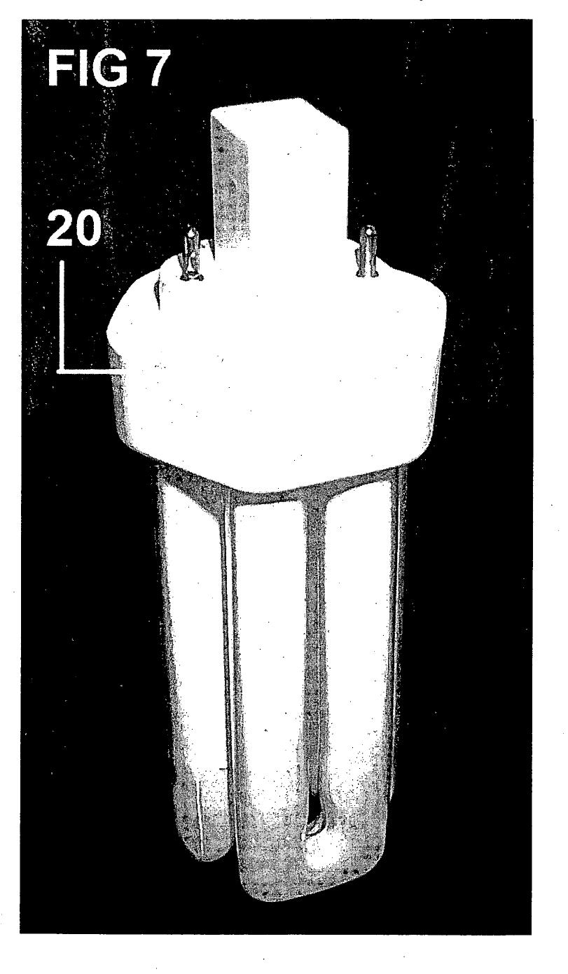

FIG. 8 shows the bloc diagram of automated on/off control

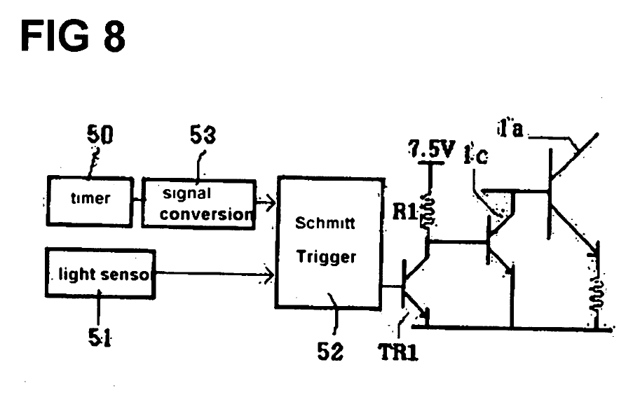

FIG. 9 shows signal conversion diagram related with the automated on/off control

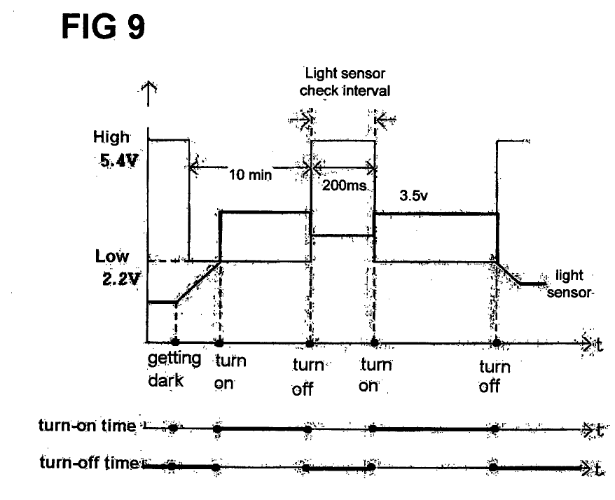

### EXPLANATION OF THE DIAGRAM

1a, 1b: switching transistors
5a, 5b: fluorescent filament condenser
6: fluorescent filament thermistor
7: connecting parts between mother unit and daughter unit
10: socket design in the mother unit that accommodates the daughter unit
20: connecting parts of the daughter unit with integrated glow starter and plug-type connectors
40: printed circuit board
50: timer
51: light sensor
52: Schmitt Trigger

1. A fluorescent lamp comprising first and second subassemblies, said first subassembly comprising a sealed glass tube including a gas therein, said tube being adapted for electrical and mechanical connection to said second subassembly, said second subassembly including circuitry to activate said gas when said first and second subassemblies are connected, said second subassembly including an on/off control responsive to ambient light in excess of a present threshold level greater than that provided by ambient sunlight.

2. A lamp as in claim 1 wherein said first subassembly includes plug in connectors and a glow start.

3. A lamp as in claim 1 wherein said second subassembly includes filament heating components and is configured for connection to an incandescent bulb receptor.

4. A lamp as in claim 2 where in said second subassembly is adapted to mate with said plug connector.

5. A sealed fluorescent tube said to be including therein a glow starter.

6. A tube as in claim 5 having first and second ends, each of said first and second ends having electrical connections for communicating with an external power source.

7. Docking apparatus for communicating with the tube of claim 6, said apparatus including high frequency ballast for activating said glow starter, said apparatus being configured for mating with an incandescent bulb receptor.
